(19) United States
(12) Patent Application Publication
(10) Pub. No.: US 2012/0076374 A1
(43) Pub. Date: Mar. 29, 2012

(54) IMAGE PROCESSING APPARATUS AND IMAGE PROCESSING METHOD

(75) Inventors: Kenichi TANAKA, Tokyo (JP); Yusuke TOMOTO, Tokyo (JP); Hirokazu NISHIMURA, Tokyo (JP)

(73) Assignee: OLYMPUS MEDICAL SYSTEMS CORP., Tokyo (JP)

(21) Appl. No.: 13/206,098

(22) Filed: Aug. 9, 2011

Related U.S. Application Data
(63) Continuation of application No. PCT/JP2011/056424, filed on Mar. 17, 2011.

(30) Foreign Application Priority Data
Jun. 24, 2010 (JP) 2010-144084

(51) Int. Cl. G06K 9/00

(52) U.S. Cl. 382/128

(57) ABSTRACT

An image processing apparatus according to the present invention includes a pixel selection unit adapted to select a pixel of interest from an image; a contrast feature value calculation unit adapted to calculate, as a contrast feature value, a value which represents an amount of change in contrast in a local region including the pixel of interest; a geometric feature value calculation unit adapted to calculate, as a geometric feature value, a value of an index which indicates whether or not a linear or massive structure is contained in the local region; an evaluation value calculation unit adapted to calculate an evaluation value by weighting each of the contrast feature value and the geometric feature value; and a region extraction unit adapted to extract a candidate region estimated to contain the linear or massive structure from the image based on a calculation result of the evaluation value.

### CROSS REFERENCE TO RELATED APPLICATION

This application is a continuation application of PCT/JP2011/056424 filed on Mar. 17, 2011 and claims benefit of Japanese Application No. 2010-144084 filed in Japan on Jun. 24, 2010, the entire contents of which are incorporated herein by this reference.

### BACKGROUND OF THE INVENTION

1. Field of the Invention

The present invention relates to an image processing apparatus and image processing method, and more particularly, to an image processing apparatus and an image processing method used for diagnosis and the like of living tissue.

2. Description of the Related Art

Recently, in order to help identify a lesion site (abnormal area) in images picked up of living tissue in a body cavity using an endoscope and the like, studies have been conducted on image processing for detecting a running pattern of submucosal blood vessels and/or a predetermined structure and the like of epithelial tissue in the images. For example, Japanese Patent Application Laid-Open Publication No. 2008-307229 discloses an image processing apparatus configured to detect a candidate lesion site with a concavo-convex structure based on an amount of change in pixel values between a pixel of interest and pixels surrounding the pixel of interest in an image obtained by a capsule endoscope.

### SUMMARY OF THE INVENTION

An image processing apparatus according to one aspect of the present invention includes: a pixel selection unit adapted to select a pixel of interest from an image picked up of living tissue; a contrast feature value calculation unit adapted to calculate, as a contrast feature value of the pixel of interest, a value which represents an amount of change in contrast in a local region including the pixel of interest and each pixel in a neighborhood of the pixel of interest; a geometric feature value calculation unit adapted to calculate, as a geometric feature value of the pixel of interest, a value of an index which indicates whether or not a linear or massive structure is contained in the local region; an evaluation value calculation unit adapted to calculate an evaluation value of the pixel of interest by weighting each of the contrast feature value and the geometric feature value such that the evaluation value will be a value in a different range depending on whether or not the pixel of interest includes part of the linear or massive structure; and a region extraction unit adapted to extract a candidate region estimated to contain the linear or massive structure from the image based on a calculation result of the evaluation value.

An image processing method according to another aspect of the present invention includes: a pixel selection step of selecting a pixel of interest from an image picked up of living tissue; a contrast feature value calculation step of calculating, as a contrast feature value of the pixel of interest, a value which represents an amount of change in contrast in a local region including the pixel of interest and each pixel in a neighborhood of the pixel of interest; a geometric feature value calculation step of calculating, as a geometric feature value of the pixel of interest, a value of an index which indicates whether or not a linear or massive structure is contained in the local region; an evaluation value calculation step of calculating an evaluation value of the pixel of interest by weighting each of the contrast feature value and the geometric feature value such that the evaluation value will be a value in a different range depending on whether or not the pixel of interest includes part of the linear or massive structure; and a region extraction step adapted to extract a candidate region estimated to contain the linear or massive structure from the image based on a calculation result of the evaluation value.

### BRIEF DESCRIPTION OF THE DRAWINGS

FIG. 1 is a diagram showing an exemplary configuration of principal part an endoscope apparatus equipped with an image processing apparatus according to an embodiment of the present invention;

FIG. 2 is a diagram showing an exemplary configuration of a rotating filter wheel included in a light source device of FIG. 1;

FIG. 3 is a diagram showing an example of transmission characteristics of each filter in a first filter group shown in FIG. 2;

FIG. 4 is a diagram showing an example of transmission characteristics of each filter in a second filter group shown in FIG. 2;

FIG. 5 is a flowchart showing an example of processing performed in the embodiment of the present invention; and

FIG. 6 is a schematic diagram showing an example of image data to be processed.

### DETAILED DESCRIPTION OF THE PREFERRED EMBODIMENT

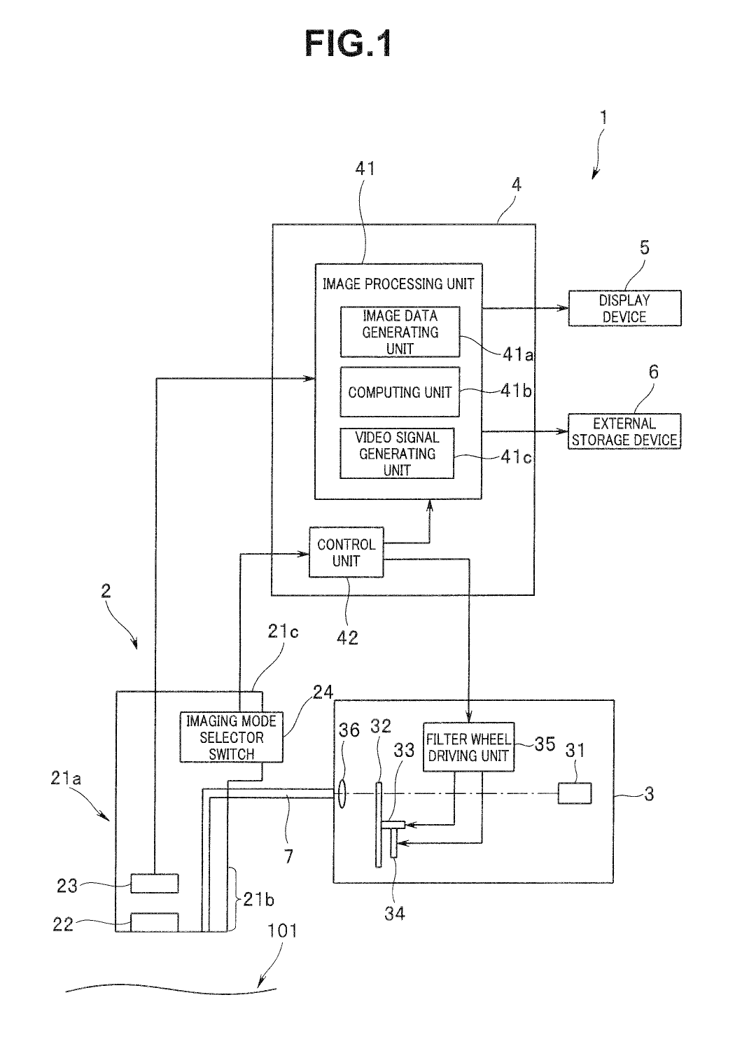

An exemplary embodiment of the present invention will be described below with reference to the drawings. FIGS. 1 to 6 concern the embodiment of the present invention.

As shown in FIG. 1, an endoscope apparatus 1 includes an endoscope 2 inserted into a body cavity of a subject and adapted to output a signal of an image picked up of an object such as living tissue 101 in the body cavity, a light source device 3 adapted to give off illuminating light to illuminate the living tissue 101, a processor 4 adapted to apply various processes to an output signal from the endoscope 2, a display device 5 adapted to display images according to a video signal from the processor 4, and an external storage device 6 adapted to store an output signal according to processing results of the processor 4.

The endoscope 2 includes an insertion portion 21a sized and shaped so that it can be inserted into the body cavity of the subject, a distal end portion 21b installed on a distal end side of the insertion portion 21a, and an operation portion 21c installed on a proximal end side of the insertion portion 21a. Also, a light guide 7 is passed through the insertion portion 21a to transmit the illuminating light given off by the light source device 3 to the distal end portion 21b.

One end face (incident end face) of the light guide 7 is detachably connected to the light source device 3. Another end face (emergent end face) of the light guide 7 is placed near an illumination optical system (not shown) installed in the distal end portion 21b of the endoscope 2. With this configuration, the illuminating light given off by the light source device 3 is emitted to the living tissue 101 through the light guide 7 connected to the light source device 3 and then through the illumination optical system (not shown) installed in the distal end portion 21b.

An objective optical system 22 and a CCD 23 are installed in the distal end portion 21b of the endoscope 2, where the objective optical system 22 is adapted to form an optical image of an object while the CCD 23 is adapted to acquire an image by picking up the optical image formed by the objective optical system 22. Also, an imaging mode selector switch 24 is installed on an operation portion 21c of the endoscope 2, where the imaging mode selector switch 24 is used to give a command to switch imaging mode between normal-light imaging mode and narrow-band imaging mode.

The light source device 3 includes a white light source 31 made up of a xenon lamp or the like, a rotating filter wheel 32 adapted to convert white light given off by the white light source 31 into frame-sequential illuminating light, a motor 33 adapted to rotationally drive the rotating filter wheel 32, a motor 34 adapted to move the rotating filter wheel 32 and the motor 33 in a direction perpendicular to an emission light path of the white light source 31, a filter wheel driving unit 35 adapted to drive the motors 33 and 34 under the control of the processor 4, and a condenser optical system 36 adapted to collect the illuminating light passing through the rotating filter wheel 32 and supply the collected light to the incident end face of the light guide 7.

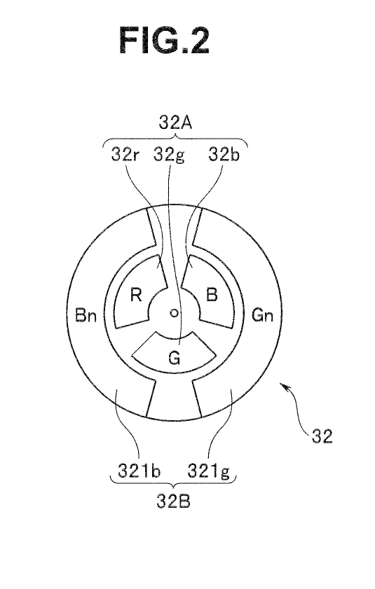

As shown in FIG. 2, the rotating filter wheel 32 has the shape of a disk whose shaft is a rotating center and includes a first filter group 32A made up of a plurality of filters installed along a circumferential direction on an inner circumferential side and a second filter group 32B made up of a plurality of filters installed along the circumferential direction on an outer circumferential side. The rotating filter wheel 32 rotates when a driving force of the motor 33 is transmitted to the rotating shaft. Except for the part in which the filters of the first filter group 32A and second filter group 32B are placed, the rotating filter wheel 32 is made of a light-shielding material.

The first filter group 32A includes an R filter 32r, a G filter 32g, and a B filter 32b installed along the circumferential direction on the inner circumferential side of the rotating filter wheel 32, where the R filter transmits light in a red wavelength band, the G filter 32g transmits light in a green wavelength range, and the B filter 32b transmits light in a blue wavelength range.

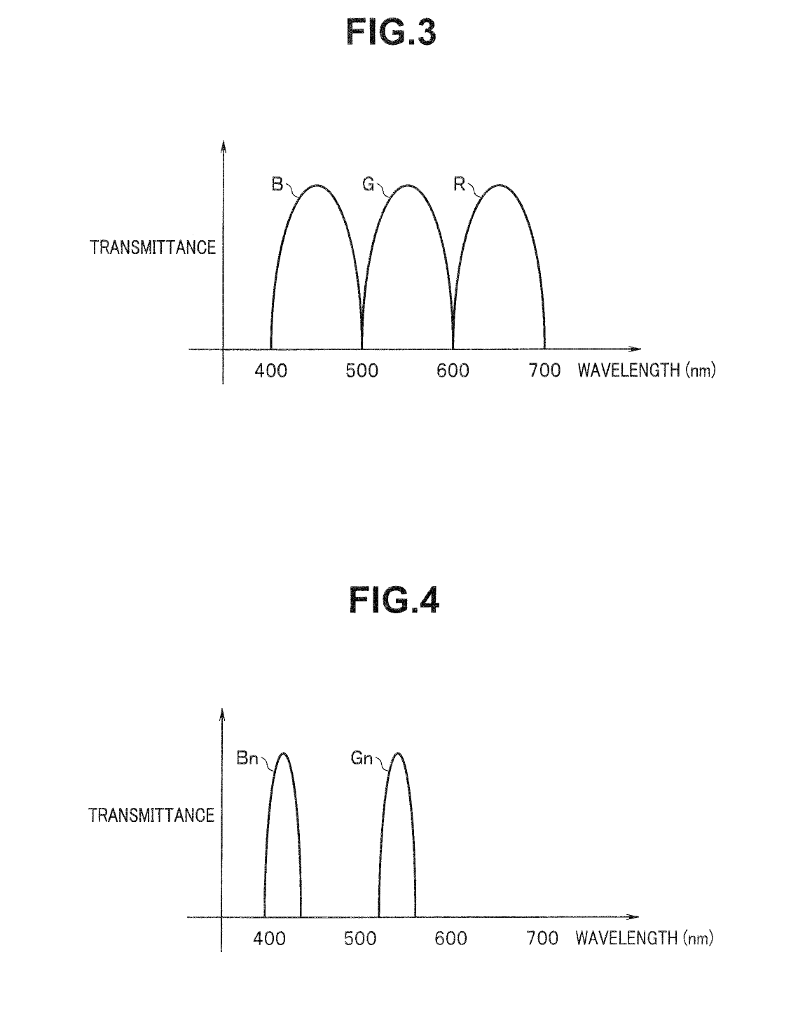

The R filter 32r is configured to transmit light (R light) in the range of 600 nm to 700 ml, for example, as shown in FIG. 3. The G filter 32g is configured to transmit light (G light) in the range of 500 nm to 600 nm, for example, as shown in FIG. 3. The B filter 32b is configured to transmit light (B light) in the range of 400 nm to 500 nm, for example, as shown in FIG. 3.

That is, the white light given off by the white light source 31 is changed into broad-band light for the normal-light imaging mode after passing through the first filter group 32A.

The second filter group 32B includes a Bn filter 321b and Gn filter 321g installed along the circumferential direction on the outer circumferential side of the rotating filter wheel 32, where the Bn filter 321b transmits blue and narrow-band light and the Gn filter 321g transmits green and narrow-band light.

The Bn filter 321b has a center wavelength set at around 415 nm and is configured to transmit light (Bn light) in a narrower band than B light, for example, as shown in FIG. 4.

The Gn filter 321g has a center wavelength set at around 540 nm and is configured to transmit light (Gn light) in a narrower band than G light, for example, as shown in FIG. 4.

That is, the white light given off by the white light source 31 is discretized by the second filter group 32B into multiple bands of narrow-band light for the narrow-band imaging mode.

The processor 4 is configured to serve functions of an image processing apparatus. Specifically, the processor 4 is configured to include an image processing unit 41 and a control unit 42. The image processing unit 41 in turn is configured to include an image data generating unit 41a, a computing unit 41b, and a video signal generating unit 41c.

Under the control of the control unit 42, the image data generating unit 41a of the image processing unit 41 applies noise reduction, A/D conversion, and other processes to an output signal of the endoscope 2 and thereby generates image data corresponding to images obtained by the CCD 23.

The computing unit 41b of the image processing unit 41 performs predetermined processing using the image data generated by the image data generating unit 41a and thereby extracts a candidate region estimated to contain a mucosal microstructure (histologic structure) of a predetermined shape from the image data. Details of the above-described predetermined processing will be described in detail later.

The video signal generating unit 41c of the image processing unit 41 applies gamma conversion, A/D conversion, and other processes to the image data generated by the image data generating unit 41a and thereby generates and outputs a video signal.

If it is detected that a command to switch to the normal-light imaging mode has been issued based on an instruction of the imaging mode selector switch 24, the control unit 42 performs control over the filter wheel driving unit 35 to cause the broad-band light for the normal-light imaging mode to be emitted from the light source device 3. Then, under the control of the control unit 42, the filter wheel driving unit 35 operates the motor 34 so as to insert the first filter group 32A in the emission light path of the white light source 31 and retract the second filter group 32B from the emission light path of the white light source 31.

On the other hand, if it is detected that a command to switch to the narrow-band imaging mode has been issued based on an instruction of the imaging mode selector switch 24, the control unit 42 performs control over the filter wheel driving unit 35 to cause the multiple bands of narrow-band light for the narrow-band imaging mode to be emitted from the light source device 3. Then, under the control of the control unit 42, the filter wheel driving unit 35 operates the motor 34 so as to insert the second filter group 32B in the emission light path of the white light source 31 and retract the first filter group 32A from the emission light path of the white light source 31.

That is, with the configuration of the endoscope apparatus 1 described above, when the normal-light imaging mode is selected, an image (normal-light image) having substantially the same coloration as when an object is viewed with the naked eye can be displayed on the display device 5 and stored in the external storage device 6. Also, with the configuration of the endoscope apparatus 1 described above, when the narrow-band imaging mode is selected, an image (narrow-band image) with blood vessels in the living tissue 101 highlighted can be displayed on the display device 5 and stored in the external storage device 6.

Now, operation of the endoscope apparatus 1 will be described.

First, after powering on various parts of the endoscope apparatus 1, a surgeon selects the normal-light imaging mode on the imaging mode selector switch 24. Then, by watching images displayed on the display device 5 when the normal-light imaging mode is selected, i.e., images having substantially the same coloration as when the object is viewed with the naked eye, the surgeon inserts the endoscope 2 into a body cavity and brings the distal end portion 21b close to a site where the living tissue 101 to be observed exists.

When the surgeon selects the normal-light imaging mode on the imaging mode selector switch 24, lights of different colors, i.e., R light, G light, and B light, are emitted in sequence from the light source device 3 to the living tissue 101, and images corresponding to the respective colors are acquired through the endoscope 2.

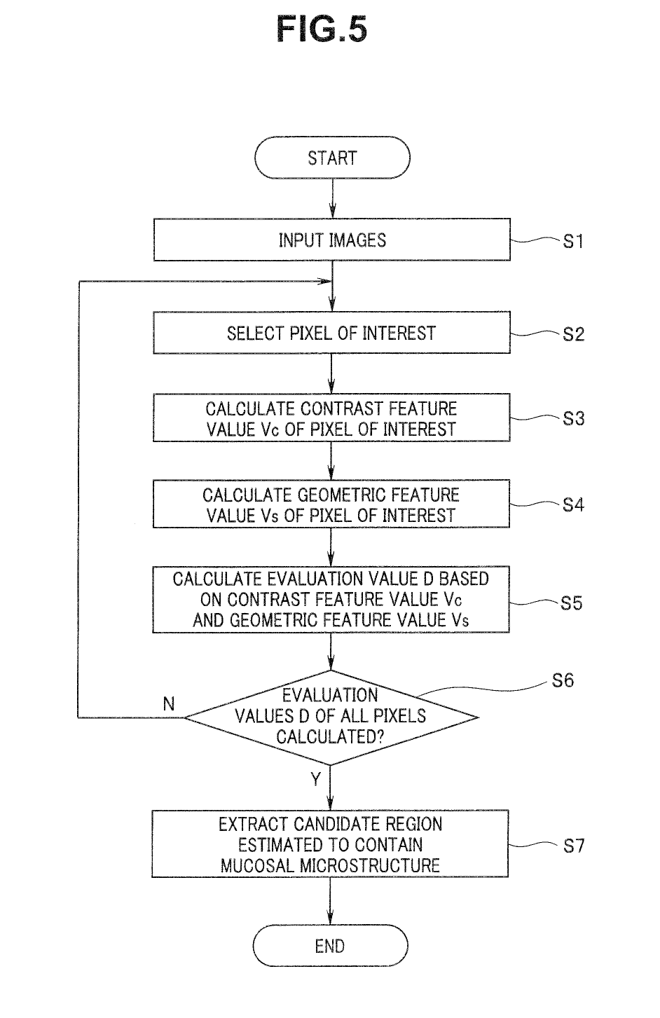

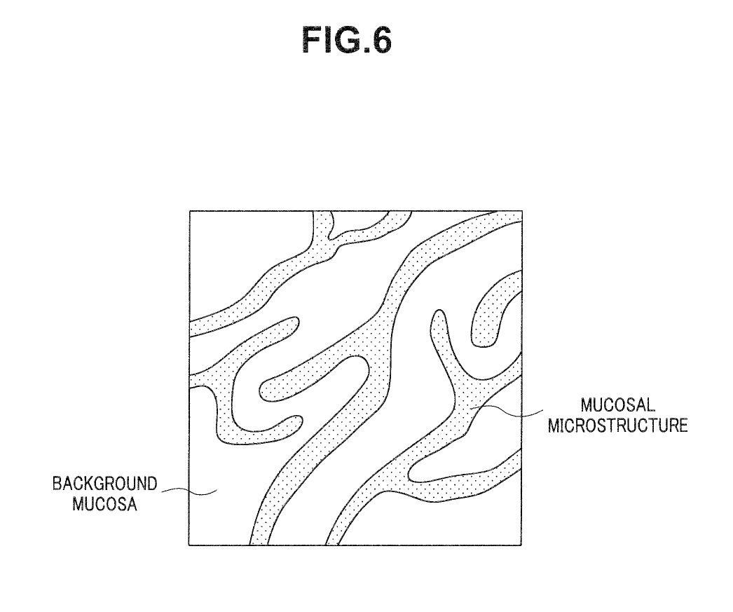

Upon receiving the image corresponding to the R light, the image corresponding to the G light, and the image corresponding to the B light, the image data generating unit 41a of the image processing unit 41 generates image data of color components corresponding to the respective images (Step S1 in FIG. 5). Incidentally, for simplicity of explanation, it is assumed in the following description that processing is performed on image data such as schematically shown in FIG. 6, in which a region corresponding to a linear mucosal microstructure (histologic structure) is indicated by a dot pattern, a region corresponding to a background mucosa is indicated by white, and a boundary line between the two regions is indicated by a fine solid line.

Based on image data generated by the image data generating unit 41a, the computing unit 41b functioning as a pixel selection unit selects one pixel of interest from the respective pixels contained in the image data (Step S2 in FIG. 5).

Subsequently, the computing unit 41b functioning as a contrast feature value calculation unit calculates, as a contrast feature value Vc of the pixel of interest, a value which represents an amount of change in contrast in a local region including the pixel of interest selected as a result of the process of Step S2 in FIG. 5 and each pixel in a neighborhood of the pixel of interest (Step S3 in FIG. 5).

Specifically, the contrast feature value Vc of the pixel of interest can be calculated, for example, based on an output value obtained by applying a known band pass filter to image data of at least one of the color components (R, G, and B) generated by the image data generating unit 41a.

Alternatively, the contrast feature value Vc of the pixel of interest can be calculated, for example, by computations disclosed in Japanese Patent Application Laid-Open Publication No. 2008-307229 using pixel values in the image data of the G component generated by the image data generating unit 41a, where the computations are intended to obtain either of an average amount Vr of change in pixel values in a direction or an amount Vdir of change in pixel values.

Incidentally, the contrast feature value Vc according to the present embodiment may be calculated using a method other than those described above.

Also, the computing unit 41b functioning as a geometric feature value calculation unit calculates, as a geometric feature value Vs of the pixel of interest, a value of an index which indicates whether or not a linear structure is contained in a local region including the pixel of interest selected as a result of the process of Step S2 in FIG. 5 and each pixel in the neighborhood of the pixel of interest (Step S4 in FIG. 5).

Specifically, the geometric feature value Vs of the pixel of interest can be calculated, for example, by acquiring eigenvalues λ1 and λ2 (where |λ1|≧|λ2|) through computations disclosed in an article by Alejandro F. Frangi, et al. entitled “Multiscale Vessel Enhancement Filtering” (LNCS, vol. 1496, Springer Verlag, Berlin, Germany, pp. 130-137) using the Hesse matrix H given by mathematical expression (1) below and then finding the value of |λ2|/|λ1| which is a ratio between the absolute values of the two eigenvalues. Incidentally the symbol L on the right-hand side of mathematical expression (1) below represents image intensity in a local location of the image, i.e., corresponds to (x₀+δx₀, s) in the article by Alejandro F. Frangi, et al. described above.

$$H = [ \begin{matrix}{h}_{11} & {h}_{12} \\ {h}_{21} & {h}_{22}\end{matrix} ] = [ \begin{matrix}\frac{{\partial }^{2} L}{\partial {x}^{2}} & \frac{{\partial }^{2} L}{\partial x \partial y} \\ \frac{{\partial }^{2} L}{\partial x \partial y} & \frac{{\partial }^{2} L}{\partial {y}^{2}}\end{matrix} ] \qquad ( 1 )$$

Alternatively, the geometric feature value Vs of the pixel of interest can be calculated, by finding a value of concentration of a luminance gradient vector disclosed, for example, in an article by Yoshinaga, et al. entitled “Contrast independent detection method of curvilinear convex regions” (Technical Report of the Institute of Electronics, Information and Communications Engineers, DSP, Digital Signal Processing 97 (10), pp. 4′-48).

Incidentally, the geometric feature value Vs according to the present embodiment may be calculated using a method other than those described above.

The processes of Steps S3 and S4 described above in FIG. 5 may be carried out in reverse order or concurrently.

On the other hand, the computing unit 41b functioning as an evaluation value calculation unit applies the contrast feature value Vc and the geometric feature value Vs to mathematical expression (2) below and thereby calculates an evaluation value D which represents a value of an index which indicates whether or not the pixel of interest selected in the process of Step S2 in FIG. 5 makes up part of a linear structure (Step S5 in FIG. 5). In other words, the computing unit 41b calculates the evaluation value D of the pixel of interest by weighting the contrast feature value Vc and the geometric feature value Vs as shown, for example, by mathematical expression (2) below.

$$D = \frac{W 1 \times Vc + W 2 \times Vs}{W 1 + W 2} \qquad ( 2 )$$

Weighting factors W1 and W2 on the right-hand side of mathematical expression (2) above are set as appropriate (or in advance) such that the evaluation value D will have a different value range, for example, between when the pixel of interest makes up part of the linear structure and when the pixel of interest does not make up part of the linear structure. Specifically, for example, by setting the weighting factors W1 and W2 described above to W1=0.4 and W2=0.6, the evaluation value D of the pixel of interest can be made relatively large even if the amount of change in contrast in the local region is small as long as there is a linear structure in the local region including the pixel of interest and each pixel in the neighborhood of the pixel of interest.

Subsequently, the computing unit 41b determines whether or not the evaluation values D of all the pixels contained in the image data have been calculated (Step S6 in FIG. 5). If it is detected that there remains any pixel whose evaluation value D has not been calculated, the computing unit 41b carries out the processes of Steps S2 to S5 in FIG. 5 again: selects a new pixel of interest from the image data and calculates the contrast feature value Vc, geometric feature value Vs, and evaluation value D of the new pixel of interest. On the other hand, if it is detected that the evaluation values D of all the pixels contained in the image data have been calculated, the computing unit 41b proceeds to the process of Step S7 in FIG. 5.

The computing unit 41b functioning as a region extraction unit extracts a candidate region estimated to contain a linear mucosal microstructure from the image data using the evaluation value D calculated for each pixel (Step S7 in FIG. 5). Specifically, for example, the computing unit 41b extracts a region containing a pixel whose evaluation value D is equal to or larger than a predetermined threshold as the candidate region described above.

Incidentally, the process of Step S7 in FIG. 5 is not limited to the one described above and may be a process which involves, for example, detecting a region estimated to contain a linear mucosal microstructure based on the amount of change in contrast, correcting a detection result through multiplication of the detection result by the evaluation value D, and thereby extracting the candidate region described above.

Then, by performing the series of processes described above, it is possible to extract a region estimated to contain a linear mucosal microstructure such as MCE (Marginal Crypt Epithelium), a pit pattern, and blood vessels from an image such as shown in FIG. 6.

On the other hand, the geometric feature value Vs according to the present embodiment is not limited to the one obtained as a value of an index which indicates whether or not a linear structure is present, and may be a value of an index which indicates, for example, whether or not a massive structure is present.

Specifically, for example, by calculating a value of concentration of a luminance gradient vector based on an output value obtained by the application of an iris filter to image data, a value of an index which indicates whether or not a massive structure is contained in a local region including a pixel of interest and each pixel in the neighborhood of the pixel of interest can be calculated as the geometric feature value Vs of the pixel of interest. Then, by calculating the evaluation value D using the geometric feature value Vs thus obtained and carrying out the process of Step S7 in FIG. 5 using the evaluation value D of each pixel, it is possible to extract a candidate region estimated to contain a massive mucosal microstructure from the image data.

Also, according to the present embodiment, the extraction of a candidate region in the process of Step S7 in FIG. 5 is not limited to a process which uses the evaluation value D, and a candidate region may be extracted, for example, by thresholding of the contrast feature value Vc and geometric feature value Vs. Specifically, for example, a region containing each pixel whose contrast feature values Vc are larger than a threshold Thre1 and whose geometric feature values Vs are larger than a threshold Thre2 may be extracted from the image data as a candidate region estimated to contain a linear (or massive) mucosal microstructure.

As described above, the present embodiment has a configuration and operation whereby a candidate region estimated to contain a linear (or massive) mucosal microstructure is extracted using two feature values—the contrast feature value Vc and geometric feature value Vs. Thus, the present embodiment can stably detect a structure of a predetermined shape even when contrast varies (fluctuates) greatly between images, or within an image, picked up of living tissue.

Also, by calculating the evaluation value D by setting the weighting factors W1 and W2 in mathematical expression (2) described above to W1<W2, the present embodiment can extract a candidate region estimated to contain the mucosal microstructure to be detected even if the contrast of the mucosal microstructure to be detected is indistinct. Specifically, if blood vessels are taken as an example, by calculating the evaluation value D by setting the weighting factors W1 and W2 in mathematical expression (2) described above to W1<W2, it is possible to extract a region with a light color tone but a distinct linear structure as a candidate region estimated to contain blood vessels.

Furthermore, by calculating the evaluation value D by setting the weighting factors W1 and W2 in mathematical expression (2) described above to W1>W2, the present embodiment can extract a candidate region estimated to contain the mucosal microstructure to be detected even if the shape of the mucosal microstructure to be detected is indistinct. Specifically, if blood vessels are taken as an example, by calculating the evaluation value D by setting the weighting factors W1 and W2 in mathematical expression (2) described above to W1>W2, it is possible to extract a region with a less distinct linear structure but a more reddish tone than surroundings as a candidate region estimated to contain blood vessels.

It should be noted that the present invention is not limited to the embodiments described above, and it is needless to say that various alterations and applications are possible without departing from the spirit of the invention.

What is claimed is:

1. An image processing apparatus comprising:
a pixel selection unit adapted to select a pixel of interest from an image picked up of living tissue;
a contrast feature value calculation unit adapted to calculate, as a contrast feature value of the pixel of interest, a value which represents an amount of change in contrast in a local region including the pixel of interest and each pixel in a neighborhood of the pixel of interest;
a geometric feature value calculation unit adapted to calculate, as a geometric feature value of the pixel of interest, a value of an index which indicates whether or not a linear or massive structure is contained in the local region;
an evaluation value calculation unit adapted to calculate an evaluation value of the pixel of interest by weighting each of the contrast feature value and the geometric feature value such that the evaluation value will be a value in a different range depending on whether or not the pixel of interest includes part of the linear or massive structure; and
a region extraction unit adapted to extract a candidate region estimated to contain the linear or massive structure from the image based on a calculation result of the evaluation value.

2. The image processing apparatus according to claim 1, wherein the contrast feature value calculation unit adopts a value calculated using either an output value obtained by applying a band pass filter to the image or a pixel value of the image as the contrast feature value of the pixel of interest.

3. The image processing apparatus according to claim 1, wherein the geometric feature value calculation unit adopts a value obtained by calculating either a ratio between absolute values of eigenvalues obtained through computations using the Hesse matrix or a degree of concentration of a luminance gradient vector as the geometric feature value of the pixel of interest.

4. An image processing method comprising:
a pixel selection step of selecting a pixel of interest from an image picked up of living tissue;
a contrast feature value calculation step of calculating, as a contrast feature value of the pixel of interest, a value which represents an amount of change in contrast in a local region including the pixel of interest and each pixel in a neighborhood of the pixel of interest;
a geometric feature value calculation step of calculating, as a geometric feature value of the pixel of interest, a value of an index which indicates whether or not a linear or massive structure is contained in the local region;
an evaluation value calculation step of calculating an evaluation value of the pixel of interest by weighting each of the contrast feature value and the geometric feature value such that the evaluation value will be a value in a different range depending on whether or not the pixel of interest includes part of the linear or massive structure; and
a region extraction step of extracting a candidate region estimated to contain the linear or massive structure from the image based on a calculation result of the evaluation value.

5. The image processing method according to claim 4, wherein the contrast feature value calculation step adopts a value calculated using either an output value obtained by applying a band pass filter to the image or a pixel value of the image as the contrast feature value of the pixel of interest.

6. The image processing method according to claim 4, wherein the geometric feature value calculation step adopts a value obtained by calculating either a ratio between absolute values of eigenvalues obtained through computations using the Hesse matrix or a degree of concentration of a luminance gradient vector as the geometric feature value of the pixel of interest.
